(19) United States
(12) Patent Application Publication
(10) Pub. No.: US 2026/0308978 A1
(43) Pub. Date: Oct. 8, 2026

(54) Gate Adapter System

(71) Applicants: Michael Patrick Angenend, Paige, TX (US); Jennifer Angenend McKeon, Paige, TX (US); Christina Nicole Angenend, Austin, TX (US)

(72) Inventors: Michael Patrick Angenend, Paige, TX (US); Jennifer Angenend McKeon, Paige, TX (US); Christina Nicole Angenend, Austin, TX (US)

(21) Appl. No.: 19/678,795

(22) Filed: May 15, 2026

Related U.S. Application Data
(60) Provisional application No. 63/782,531, filed on Apr. 2, 2025.

(51) Int. Cl. E06B 11/02; E05B 47/00; E05F 15/70; F21V 33/00; H04N 7/18

(52) U.S. Cl. CPC E06B 11/026; E05B 47/0002; E05F 15/70; E05Y 2900/40; F21V 33/00; H04N 7/18

(57) ABSTRACT

The present disclosure provides a gate adapter system with one or more gate assemblies configured to receive a gate. In some embodiments, the one or more assemblies may include a gate mounting post, a front side panel, a post side panel, and a securing plate. In some aspects, a separation between the front side panel and the post side panel may define a channel configured to receive at least one ballast, wherein the at least one ballast may be configured to stabilize the gate with its weight. In some aspects, the securing plate may be configured to secure the at least one ballast by connecting to the front side panel and the post side panel.

### CROSS-REFERENCE TO RELATED APPLICATION

This application claims priority to and the full benefit of United States Provisional Patent Application Ser. No. 63/782,531 (filed Apr. 2, 2025, and titled “Gate Adapter System”), the entire contents of which are incorporated in this application by reference.

### BACKGROUND

Traditionally, temporary perimeters for construction areas, temporary work zones, or special events are secured by implementing gates that require digging or drilling holes into the ground. This enables workers to insert posts or other support structures into the ground that are configured to connect to gate panels or barriers. This method is widely used as a means to securely create entry and exit points. Placing the posts or support structures into the ground provides the necessary stability to withstand physical forces from people, vehicles, animals, and the environment.

For example, a construction zone may be placed in the middle of a populated city to develop a commercial building. The construction company would have a heavy interest in putting up a gate that prohibits unauthorized individuals from entering the construction zone without permission. A gate that is unstable or subject to being toppled has the potential to injure people and damage the construction zone or nearby objects. In a populated city, there are a variety of environmental factors that may put stress onto the gate like storms, accidental impacts, or even bad actors. Therefore, having a gate with a strong support foundation is critical.

Unfortunately, there are certain drawbacks to drilling or digging into the ground. The drilling or digging results in damage to the ground surface. Eventually, the damage will either be fixed with a substantial amount of time and resources, or the damage remains a potential hazard or eyesore. In addition to aesthetic concerns, ground disruption may interfere with existing infrastructure, resulting in damage to drainage systems or underground utilities. These drawbacks increase the likelihood of accidents and project delays, all leading to increased costs and difficulty in project completion.

What is needed is a way to temporarily install gates without the damage caused by digging or drilling. This may be achieved by attaching the gate to a weighted device or device configured to receive weight. If a temporary perimeter is able to switch to a device that safely stabilizes gating without any damage to the ground, it may significantly reduce the cost and damage caused by the digging and drilling typically used to install gating at a construction zone.

### SUMMARY OF THE DISCLOSURE

The present disclosure provides a gate adapter system. In some embodiments, the gate adapter system may include one or more gate assemblies, one or more gate mounting posts, and a channel configured to receive at least one ballast. In some implementations, the at least one ballast is configured to stabilize a gate connectable to the gate adapter system. In some embodiments, a securing plate may be used to further retain the ballast.

In some embodiments, the gate adapter system may include one or more gate assemblies. In some implementations, one or more gate assemblies may include at least one gate mounting post that may be vertically oriented from the one or more gate assemblies, wherein the at least one gate mounting post may be configured to receive a gate. In some aspects, the one or more gate assemblies may include a post side panel and a front side panel parallel to the post side panel, wherein a separation between the front side panel and the post side panel defines a channel configured to receive at least one ballast configured to provide stabilizing weight to the gate adapter system. In some implementations, a securing plate may be attachable to the post side panel and the front side panel, wherein the securing plate may be configured to retain at least one ballast within the channel and prevent displacement during use.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates a gate adapter system, according to some embodiments of the present disclosure.

FIG. 2 illustrates a gate adapter system with a sliding gate, according to some embodiments of the present disclosure.

FIG. 3 illustrates a gate adapter system with a gate, according to some embodiments of the present disclosure.

FIG. 4 illustrates a locking assembly for a gate adapter system, according to some embodiments of the present disclosure.

FIG. 5 illustrates a front gate assembly of a gate adapter system, according to some embodiments of the present disclosure.

FIG. 6 illustrates a back gate assembly of a gate adapter system, according to some embodiments of the present disclosure.

FIG. 7 illustrates a front gate assembly attached to a barrier, according to some embodiments of the present disclosure.

FIG. 8 illustrates a gate adapter system, according to some embodiments of the present disclosure.

FIG. 9 illustrates an electronic gate adapter system, according to some embodiments of the present disclosure.

FIG. 10 illustrates a gate adapter system, according to some embodiments of the present disclosure.

FIG. 11 illustrates a gate adapter system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for a gate adapter system. According to the present disclosure, a gate adapter system may include a locking assembly, a front gate assembly, and a back gate assembly. In some embodiments, the gate adapter system may provide the means for a gate to be secured to one or more ballasts, such as barriers or other weighted means. In some aspects, the one or more ballasts may provide the weight and stability to operate the gate without drilling into the ground. In some aspects, the gate adapter system may utilize the locking assembly, the front gate assembly, and the back gate assembly to secure onto the one or more ballasts.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Gate adapter system: as used herein refers to a system configured to attach a gate to one or more ballasts. In some aspects, the one or more ballasts may provide the weight and stability to operate the gate. In some implementations, the gate adapter system may include a locking assembly, a front gate assembly, and a back gate assembly.

Ballast channel: as used herein refers to the space between a post side panel and a front side panel configured to receive a ballast, such as a barrier or other type of weight.

Securing plate: as used herein refers to a device configured to secure a ballast in place once positioned within the ballast channel, wherein the securing plate may be connected to a post side panel and a front side panel by one or more attachment mechanisms, such as bolts, clamps, or welds.

Gate mounting post: as used herein refers to the post configured to receive the gate of the gate adapter system. In some aspects, the gate mounting post may include one or more attachment mechanisms such as hinges, rollers, attachment locks, or track mechanisms, which may include one or more wheels. As nonlimiting examples, a gate may be a swing gate, a slide gate, pivot gate, barrier arm, gate arm, cantilever gate, or bi-folding gate.

Ballast: as used herein refers to a device configured to stabilize the gate adapter system. In some aspects, the ballast may be configured to weigh down the gate adapter system, wherein the gate adapter system may include a channel configured to receive the ballast. In some aspects, the ballast may include solid weights, water-filled objects, or objects filled with other materials such as sand, concrete, or other media. In some aspects, the ballast may include a barrier.

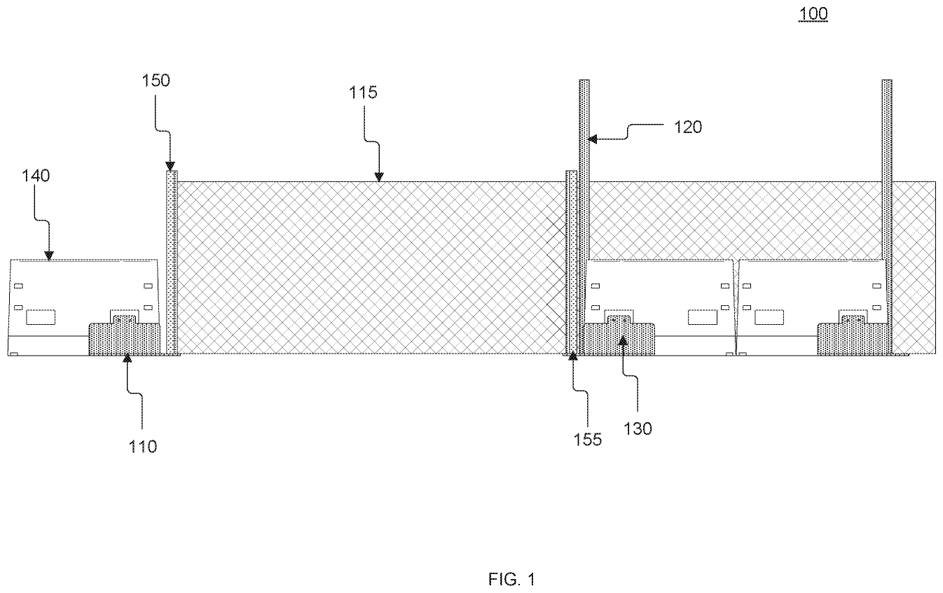

Referring now to FIG. 1, a gate adapter system, according to some embodiments of the present disclosure, is illustrated. In some embodiments, the gate adapter system 100 may include one or more gate assemblies 110. In some implementations, the one or more gate assemblies 110 may include at least one gate mounting post 120 that may be vertically oriented from the one or more gate assemblies 110, wherein the at least one gate mounting post 120 may be configured to receive a gate 115. In some aspects, the one or more gate assemblies 110 may include a post side panel 130 and a front side panel, wherein the separation between the front side panel and the post side panel 130 may define a channel configured to receive at least one ballast 140.

In some aspects, the at least one ballast 140 may be configured to provide stabilizing weight to the gate adapter system 100. In some implementations, the one or more gate assemblies 110 may include a securing plate (not shown) attachable to the post side panel 130 and the front side panel, wherein the securing plate may be configured to retain the at least one ballast 140 within the channel and prevent displacement during use. In some embodiments, the post side panel 130, front side panel, and the securing plate may include one or more holes configured to receive one or more bolts, wherein the one or more bolts may secure the securing plate to the post side panel 130 and the front side panel. By way of example and not limitation, the post side panel 130, the front side panel, and the securing plate may form a rigid structure to maintain the position of the at least one ballast 140 within the channel. In some aspects, the at least one ballast 140 may include a barrier, wherein the gate adapter system 100 may be configured to connect to a series of barriers that surrounds a perimeter.

In some embodiments, the one or more gate assemblies 110 may include a locking assembly, a front gate assembly, and a back gate assembly. In some aspects, the one or more gate assemblies 110 may be aligned on a perimeter, as a non-limiting example, wherein the one or more gate assemblies 110 may be configured to receive a gate 115 configured to selectively permit or restrict access. In some implementations, the gate 115 may be connected with one or more hinges or slidably coupled to the one or more gate assemblies 110. In some aspects, the gate 115 may provide controlled entry and exit of personnel, vehicles, or equipment, as non-limiting examples.

In some embodiments, the front gate assembly and back gate assembly may be configured to connect to the gate 115, wherein the at least one gate mounting post 120 may include one or more attachment mechanisms configured to receive the gate 115. By way of example and not limitation, the gate 115 may be a sliding gate, wherein the one or more attachment mechanisms include tracks or rollers for the gate to slide in and out of. In some embodiments, the one or more gate assemblies 110 may be positioned on the sides of an opening configured to receive the gate, wherein the front gate assembly and the back gate assembly may be positioned on one side opposite of the locking assembly.

In some embodiments, the front gate assembly may be adjacent to the opening and the back gate assembly may be a predetermined distance away from the front gate assembly, wherein the space between the front gate assembly and the back gate assembly may receive the gate 115. For example, the gate 115 may slide along the tracks of the front gate assembly and the back gate assembly, wherein the back gate assembly provides a stop for the gate 115 in the fully closed position. In some implementations, a locking assembly may be configured opposite to the front gate assembly, wherein the locking assembly may be adjacent to the gate on the other side of the front gate assembly.

In some aspects, the locking assembly may be configured as a location to shut the gate 115, wherein the locking assembly may receive a lock that connects the gate 115 to the locking assembly. In some aspects, the locking assembly may include a locking mechanism configured to lock the gate 115 into place. In some embodiments, the locking assembly provides a physical stop for the gate 115 in the fully closed position, preventing the gate from over-extending. In some embodiments, the locking assembly may include a locking post receiver 150 and the front gate assembly may include a patch post receiver 155. In some implementations, the locking post receiver 150 and patch post receiver 155 may be configured to connect the gate adapter system 100 to fencing around the perimeter. In some aspects, the locking post receiver 150 may include the locking mechanism configured to receive the gate 115. In some implementations, the gate adapter system 100 may include an anti-fall mechanism, wherein the anti-fall mechanism may be configured to prevent the gate 115 from falling over, wherein the anti-fall mechanism may stabilize or balance the gate adapter system 100.

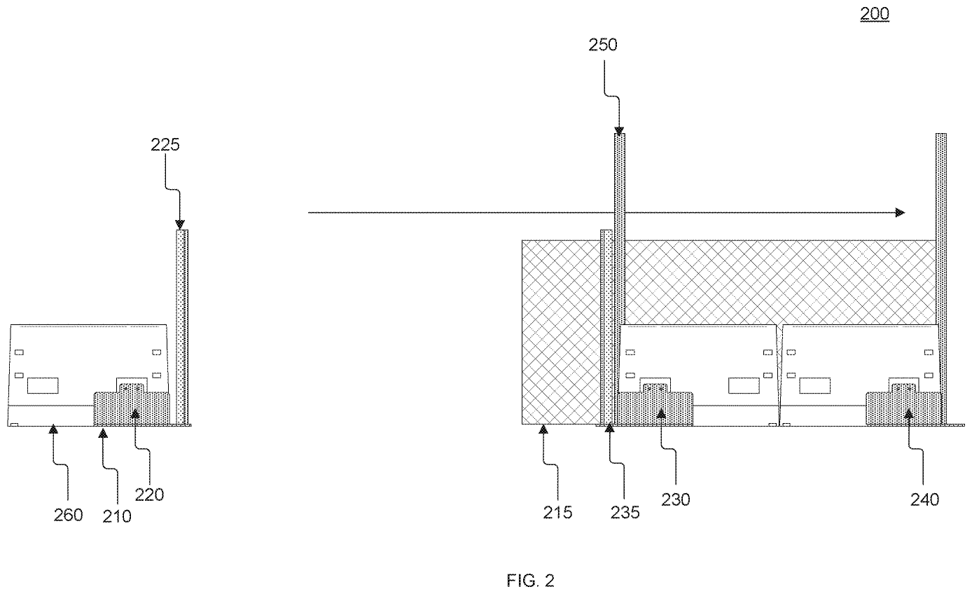

Referring now to FIG. 2, a gate adapter system with a sliding gate, according to some embodiments of the present disclosure, is illustrated. In some embodiments the gate adapter system 200 may include one or more gate assemblies 210, wherein the one or more gate assemblies 210 may include a locking assembly 220, a front gate assembly 230, and a back gate assembly 240. In some aspects, the gate adapter system 200 may be configured to receive a gate 215. By way of example and not limitation, the gate 215 may include a sliding gate.

In some embodiments, the locking assembly 220 may be opposite of the front gate assembly 230, and the back gate assembly 240. In some implementations, the front gate assembly 230 may include a patch post receiver 235, and the locking assembly 220 may include a locking post 225. In some implementations, a space between the locking assembly 220 and the front gate assembly 230 may be configured to include the gate 215, wherein the gate 215 may open and close to allow or deny access through the space. In some aspects, the patch post receiver 235 and locking post receiver 225 may be configured to receive a fencing surrounding a construction zone, as a non-limiting example.

In some embodiments, the front gate assembly 230 and the back gate assembly 240 may include gate mounting posts 250, wherein the gate mounting posts 250 may be configured to attach to the gate 215. In some implementations, the gate mounting posts 250 may include an attachment mechanism configured to connect to the gate. In some aspects, the attachment mechanism may include a track, as a non-limiting example, wherein the track may include one or more wheels configured to slide the gate in and out between the gate adapter system 200. In some embodiments, the one or more assemblies 210 may be configured to receive at least one ballast 260 configured to stabilize the gate adapter system 200 with its weight.

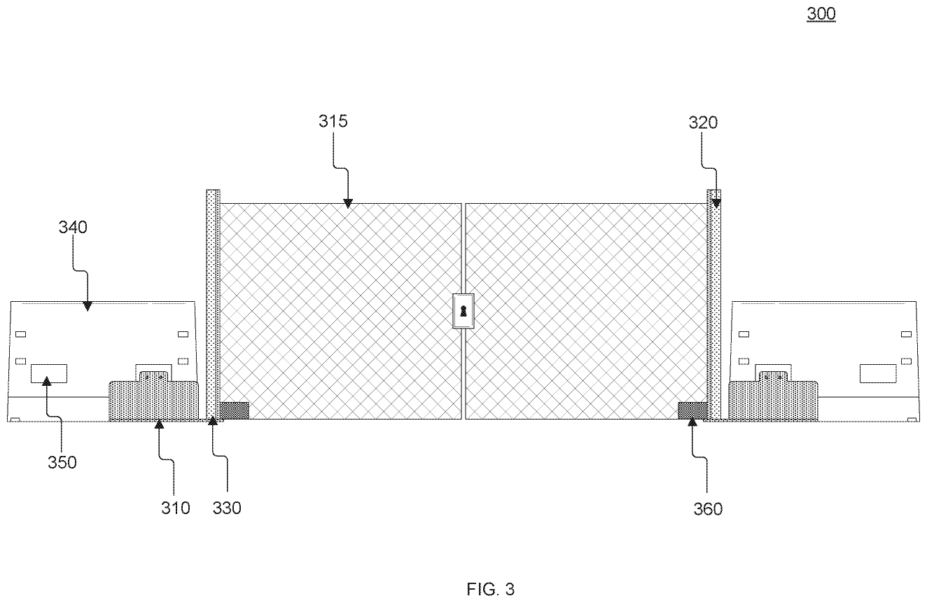

Referring now to FIG. 3, a gate adapter with a gate, according to some embodiments of the present disclosure, is illustrated. In some embodiments, the one or more gate assemblies 310 may include a gate mounting post 320 and a channel. In some embodiments, a patch post receiver 330 may be optionally included. In some aspects, the channel may be defined by a front side panel and a post side panel.

In some embodiments, the channel may be configured to receive at least one ballast 340, wherein the at least one ballast 340 may be configured to provide weight to stabilize the gate adapter system 300. In some aspects, the at least one ballast 340 may include a barrier, as a non-limiting example. By way of example and not limitation, the barrier may include one or more apertures 350 configured to receive a securing plate configured to connect to the front side panel and post side panel, wherein the securing plate locks the barrier into position. In some embodiments, the optional patch post receiver 330 may be configured to connect the gate adapter system 300 to fencing or to mount accessories such as cameras or sensors.

In some embodiments, the gate mounting posts 320 may include one or more attachment mechanisms, wherein the one or more attachment mechanisms may include hinges attachable to the gate. In some aspects, a gate 315 may be configured to open along the hinge of the gate mounting posts. By way of example and not limitation, the gate 315 may include one side that opens inward toward a secured area. By way of example and not limitation, the gate may include two portions that open inward. In some embodiments, the gate adapter system 300 may include one or more stopping mechanisms 360, wherein the one or more stopping mechanisms 360 may be devices configured to block the gate from opening in a certain direction. By way of example and not limitation, the gate adapter system 300 may utilize the one or more stopping mechanisms 360 to ensure that the gate 315 only opens inwards. In some aspects, the one or more stopping mechanisms 360 may include obstructions along the area where the gate 315 meets the gate mounting posts 320, wherein the one or more stopping mechanisms 360 prevent the gate 315 from moving along the hinge in a specific direction.

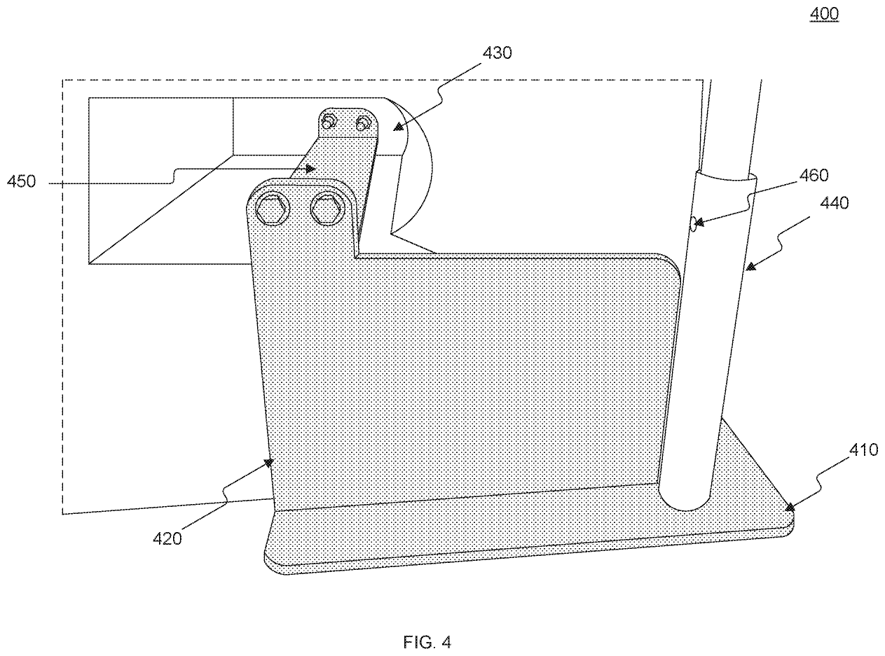

Referring now to FIG. 4, a locking assembly for a gate adapter system, according to some embodiments of the present disclosure, is illustrated. In some embodiments, the locking mechanism 400 may include a bottom plate 410, a post side panel 420, and a front side panel 430, a locking post receiver 440, and a securing plate 450. In some implementations, the bottom plate 410 may include a top portion and a bottom portion, wherein the post side panel 420, the front side panel 430, and the locking post receiver 440 may protrude from the top portion. In some aspects, the bottom portion may be configured to rest against the ground.

In some embodiments, the post side panel 420 and the front side panel 430 may protrude parallelly from another, wherein the space between the post side panel 420 and the front side panel 430 may include a ballast channel configured to receive the width of one or more barriers. In some implementations, the locking post receiver 440 may include a hollow cylindrical structure that protrudes from the top portion of the bottom plate 410, wherein the locking post receiver 440 may be configured to receive a locking post. In some embodiments, the locking post receiver 440 may include one or more apertures 460. By way of example and not limitation, the locking post receiver 440 may be configured to receive the locking post, wherein the locking post may include one or more attachment mechanisms configured to interact and lock into the locking post receiver. In some aspects, the one or more attachment mechanisms may be secured into the one or more apertures 460.

In some embodiments, the securing plate 450 may include a plate configured to extend the width of the ballast channel, wherein the securing plate 450 may be attachable to the top of the post side panel 420 and the front side panel 430. In some implementations, the securing plate 450 may be secured to the post side panel 420 and the front side panel 430 by one or more bolts, wherein the post side panel 420 and the front side panel 430 may include holes for the one or more bolts. In some embodiments, the locking post may be secured to fencing that may surround a barricaded area. In some aspects, the locking post may include a locking mechanism configured to hold the gate closed, wherein the locking assembly 400 may be placed on one side of the gate opening, wherein the gate opens away from the locking assembly 400.

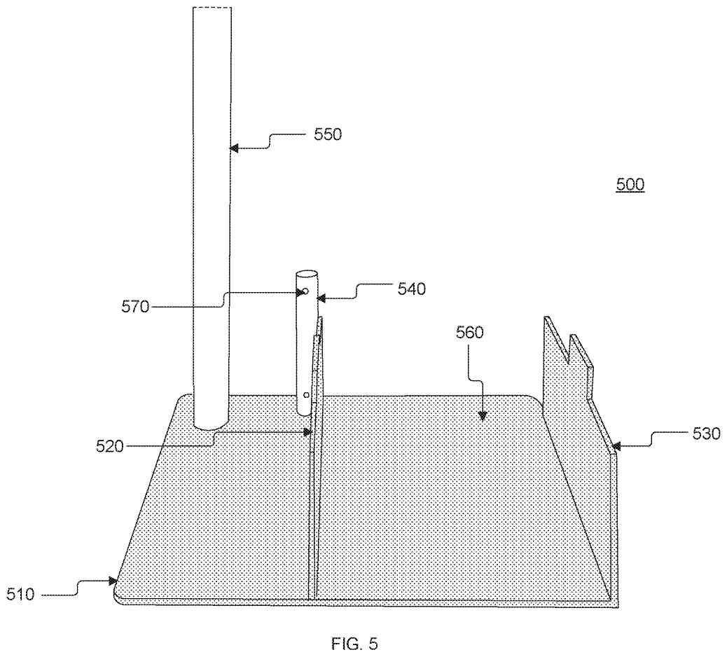

Referring now to FIG. 5, a front gate assembly of a gate adapter system, according to some embodiments of the present disclosure, is illustrated. In some embodiments, the front gate assembly 500 may include a bottom plate 510, a post side panel 520, a front side panel 530, a patch post receiver 540, a gate mounting post 550, and a securing plate (not shown). In some implementations, the bottom plate 510 may include a top portion and a bottom portion, wherein the post side panel 520, the front side panel 530, the patch post receiver 540, and the gate mounting post 550 may protrude from the top portion. In some aspects, the bottom portion may be configured to rest against the ground.

In some embodiments, the post side panel 520 and the front side panel 530 may protrude parallelly from another, wherein the space between the post side panel 520 and the front side panel 530 may include a ballast channel 560 configured to receive the width of one or more barriers. In some embodiments, the securing plate (not shown) may include a plate configured to extend the width of the ballast channel 560, wherein the securing plate may be attachable to the top of the post side panel 520 and the front side panel 530. In some implementations, the securing plate may be secured to the post side panel 520 and the front side panel 530 by one or more bolts, wherein the post side panel 520 and the front side panel 530 may include holes for the one or more bolts.

In some embodiments, the gate mounting post 550 may be configured to receive a gate, wherein the gate mounting post 550 may be configured to interact with the gate to connect it to the gate adapter system. In some implementations, the patch post receiver 540 may include a hollow cylindrical structure that protrudes from the top portion of the bottom plate 510, wherein the patch post receiver 540 may be configured to receive a patch post. In some embodiments, the patch post receiver 540 may include one or more apertures 570. By way of example and not limitation, the patch post receiver 540 may be configured to receive the patch post, wherein the patch post may include one or more attachment mechanism configured to interact and lock into the patch post receiver 540. In some embodiments, patch post may be configured to receive fencing that may be included around the perimeter of a barricaded area, as a non-limiting example.

In some embodiments, the front slide gate assembly 500 may be configured to attach to the first of one or more barricades configured to receive a gate. In some aspects, the front gate assembly 500 may be configured to receive and mount the gate, wherein once received, the gate may move along the gate adapter system.

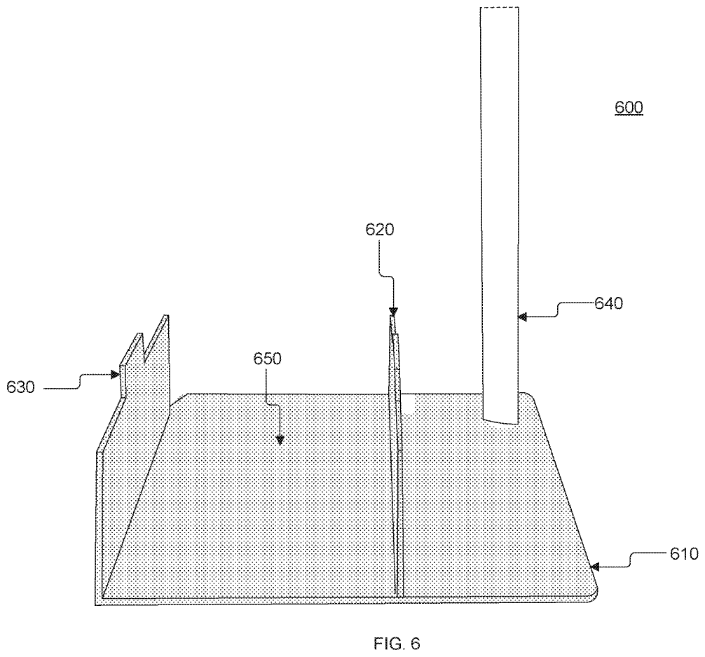

Referring now to FIG. 6, a back gate assembly of a gate adapter system, according to some embodiments of the present disclosure, is illustrated. In some embodiments, the back gate assembly 600 may include a bottom plate 610, a post side panel 620, a front side panel 630, a gate mounting post 640, and a securing plate (not shown). In some implementations, the bottom plate 610 may include a top portion and a bottom portion, wherein the post side panel 620, the front side panel 630, and the gate mounting post 640 may protrude from the top portion. In some aspects, the bottom portion may be configured to rest against the ground.

In some embodiments, the post side panel 620 and the front side panel 630 may protrude parallelly from another, wherein the space between the post side panel 620 and the front side panel 630 may include a ballast channel 650 configured to receive the width of one or more barriers. In some embodiments, the securing plate may include a plate configured to extend the width of the ballast channel 650, wherein the securing plate may be attachable to the top of the post side panel 620 and the front side panel 630. In some implementations, the securing plate may be secured to the post side panel 620 and the front side panel 630 by one or more bolts, wherein the post side panel 620 and the front side panel 630 may include holes for the one or more bolts.

In some embodiments, the gate mounting post 640 may be configured to receive a gate, wherein the gate mounting post 640 may be configured to interact with the gate to connect it to the gate adapter system. In some implementations, the back slide gate assembly 600 may be coupled with a front slide gate assembly, wherein the gate may move along the gate adapter system through its connection to the gate mounting post 640 for the back gate assembly 600 and a gate mounting post 640 for the front gate assembly, or if a slide gate is removed.

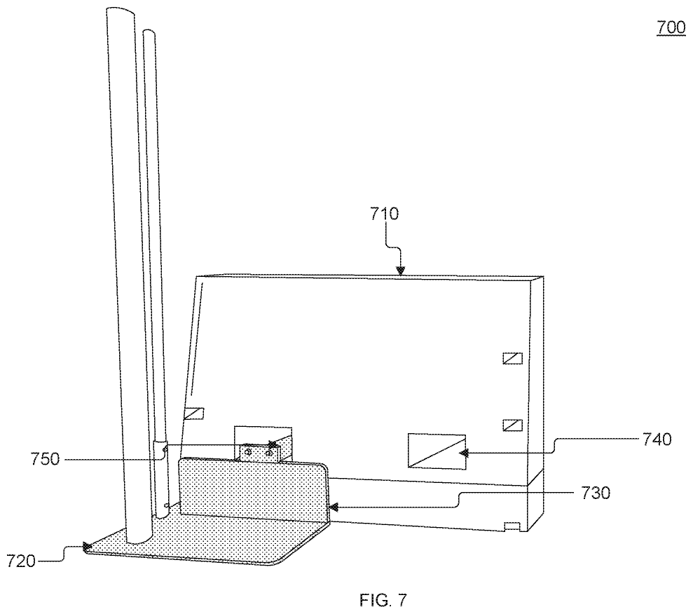

Referring now to FIG. 7, a front slide gate assembly attached to a barrier, according to some embodiments of the present disclosure, is illustrated. In some embodiments, the front gate assembly 700 may be placed under the barrier 710, wherein the barrier 710 may rest within a ballast channel on a bottom plate 720. In some aspects, the barrier 710 may be between the post side panel 730 and the front side panel. In some implementations, the barrier may include one or more slots 740, wherein the one or more slots 740 may be configured to receive a securing plate 750.

In some embodiments, the securing plate 750 may be placed in the one or more slots of the barrier 740, wherein the securing plate 750 may be attached onto the post side panel 730 and the front side panel to secure the barrier 710 in position. By way of example and not limitation, one or more bolts may attach the securing plate 750 onto the post side panel 730 and the front side panel. In some implementations, the barrier 710 may be filled with water to further solidify its placement on the ground and within the front slide gate assembly 700.

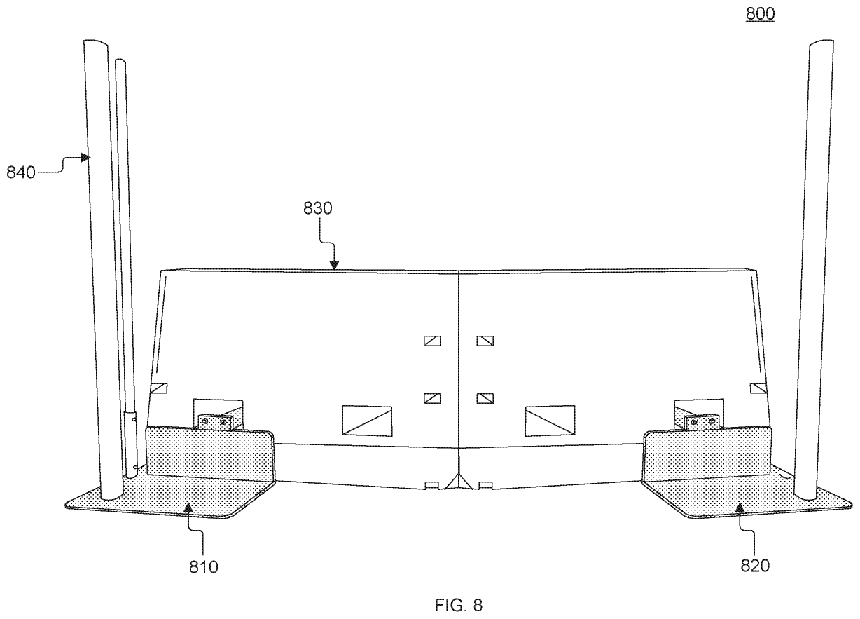

Referring now to FIG. 8, a gate adapter system, according to some embodiments of the present disclosure, is illustrated. In some embodiments, the gate adapter system 800 may include a front gate assembly 810 and a back gate assembly 820. In some implementations, the gate adapter system 800 may be connected to one or more barriers 830, wherein the gate adapter system 800 may be configured to receive a gate. In some aspects, the weight of the one or more barriers 830 may provide stability for the gate.

In some embodiments, the front slide gate assembly 810 may be configured closest to the opening of the gate, wherein the gate may attach to the gate adapter system 800 through the front gate assembly 810. In some implementations, the back gate assembly 820 may be configured as an end point for the gate's movement. In some embodiments, a locking assembly may be attached at the other side of the gate, wherein the locking assembly may be configured to assist in locking the gate closed.

In some embodiments, gate mounting posts 840 on the front gate assembly 810 and the back gate assembly 820 may include one or more track mechanisms, wherein the one or more track mechanisms may be configured to receive the gate. By way of example and not limitation, the one or more track mechanisms may include one or more wheels at the top and bottom of the gate mounting posts 840, wherein the gate may fit between the one or more wheels and slide in and out of the gate adapter system 800.

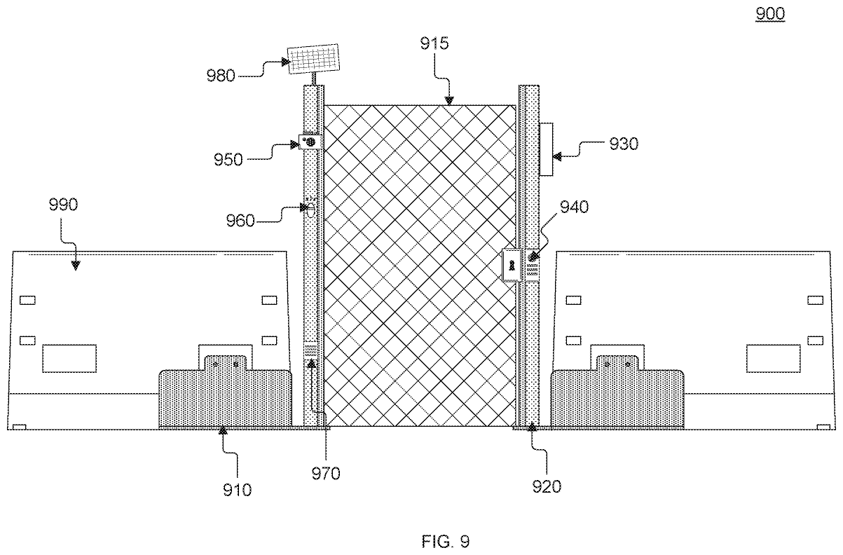

Referring now to FIG. 9, a gate adapter system with electronic access control, according to some embodiments of the present disclosure, is illustrated. In some embodiments, the gate adapter system 900 may include one or more gate assemblies 910 and one or more gate mounting posts 920. In some implementations, the one or more gate assemblies 910 may be configured to receive at least one ballast 990 configured to stabilize the gate adapter system 900 with its weight. In some aspects, the at least one ballast 990 may include a barrier.

In some embodiments, the one or more gate assemblies 910 may include one or more gate mounting posts 920, wherein the one or more gate mounting posts 920 may protrude vertically from the one or more gate mount assemblies 910. In some aspects, the one or more gate mounting posts 920 may be configured to connect the electronic gate adapter system 900 to a gate 915. In some implementations, the gate 915 may be configured for individuals to enter and exit the construction zone. In some aspects, the gate 915 may be a personnel gate, as a non-limiting example.

In some embodiments, the electronic gate adapter system 900 may be electronically capable, wherein the electronic gate adapter system 900 may include a power supply 930. While illustrated as a personnel gate, any motorized and automated implementation of the present invention may be implemented in a manner that complies with applicable local, state, or federal safety regulations. In some implementations, the system may include an electronic lock 940, a camera 950, a light mechanism 960, and one or more sensors 970, which may receive energy from the power supply 930. In some aspects, the power supply 930 may include wiring that may be spread across the electronic gate adapter system 900 or may include a self-contained power source such as solar panels 980 or batteries.

In some embodiments, the electronic lock 940, the camera 950, the light mechanism 960, and the one or more sensors 970 may be connected to the power supply through the wiring. In some aspects, the electronic lock, the camera, the light mechanism, and the one or more sensors may include their own power supply, wherein their own power supply may include solar panels 980, batteries, or mechanical energy.

In some implementations, the electronic lock 940 may be configured to lock the gate 915 preventing it from opening. In some aspects, the electronic lock 940 may include a number pad, as a non-limiting example, wherein an individual may need to use a code pressing the numbers on the number pad to lock and unlock the electronic lock 940. In some embodiments, the camera 950 may be configured to monitor the gate 915, wherein the camera 950 may record or photograph the gate 915. In some aspects, the camera 950 may be configured to monitor individuals who pass through the gate 915. In some implementations, the camera 950 may be configured to identify individuals. In some aspects, the camera 950 may be communicatively coupled to the electronic lock 940, wherein the camera 950 may identify and confirm an individual's identity to grant them access to the gate 915.

In some embodiments, the light mechanism 960 may be configured to notify whether the gate 915 may be opened or closed, or lock or unlocked, as non-limiting examples. By way of example and not limitation, the light mechanism 960 may include a red light and a green light, wherein a red light indicates that the gate 915 may be locked or closed, and a green light may indicate that the gate 915 may be unlocked or opened. In some aspects, the light mechanism 960 may include one or more flashing lights, wherein the one or more flashing light 960 may direct traffic to the gate 915 or indicate the presence of the gate 915, as non-limiting examples.

In some implementations, the one or more sensors 970 may be configured to detect and scan an area before the gate 915. In some aspects, the one or more sensors 970 may be configured as proximity, usage, strain, impact, or intrusion sensors, as non-limiting examples. In some aspects, the one or more sensors 970 may be configured to scan an ID or badge, as non-limiting examples, wherein recognition of the ID or badge may confirm or deny access to the gate 915, wherein the one or more sensors 970 may be communicatively coupled to the electronic lock 940. By way of example and not limitation, the one or more sensors 970 or the camera 950 may be configured to scan license plates, tags, or barcodes, as non-limiting examples, wherein the authentication by the one or more sensors 970 or the camera 950 may be configured to automatically open or close the gate 915.

In some aspects, the one or more sensors 970 may be communicatively coupled to the electronic lock 940, wherein the one or more sensors 970 may be configured to send signals that lock or unlock the electronic lock 940. In some aspects, the gate 915 may include motorized or automated mechanism configured to facilitate the automatic opening and closing of the gate 915 in response to signals received from the one or more sensors 970, electronic lock 940, or the camera 950, as non-limiting examples.

In some implementations, the one or more sensors, the camera 950, and the electronic lock 940 may include an alarm mechanism, wherein unauthorized or forced entry into the gate 915 may be configured to produce a sound from the alarm mechanism. In some aspects, the gate 915 may be configured to receive signage, advertisements, or flags, as non-limiting examples. In some aspects, the gate 915 may be configured to receive barbed wire or tape, as non-limiting examples

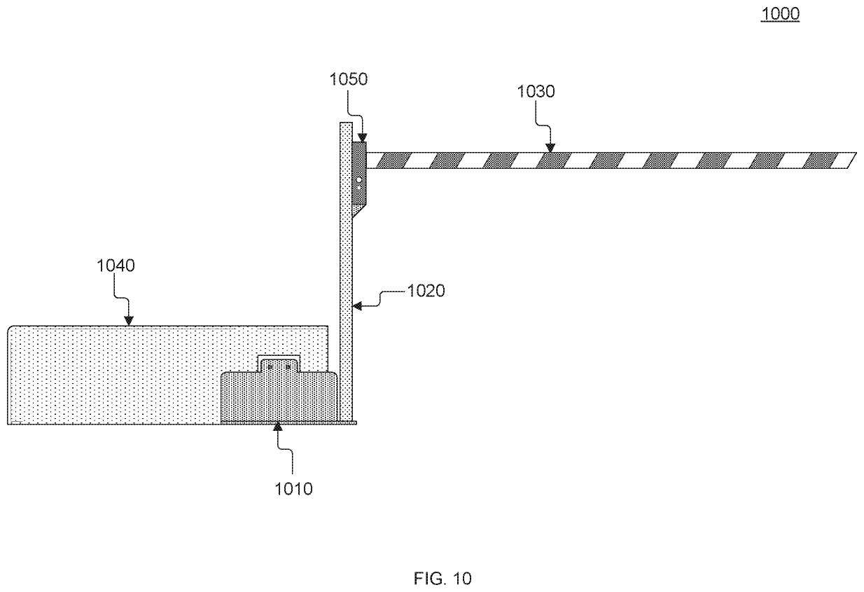

Referring now to FIG. 10, a gate adapter system, according to some embodiments of the present disclosure, is illustrated. In some embodiments, the gate adapter system 1000 may include a gate assembly 1010, a gate mounting post 1020, a gate 1030, and a ballast 1040. In some embodiments, the gate assembly 1010 may include the gate mounting post 1020, wherein the gate mounting post 1020 may vertically protrude from the gate assembly 1010. In some aspects, the gate 1030 may include a horizontal pole that may be connected perpendicularly to the gate mounting post 1020. In some implementations, the horizontal pole may be configured to lift upwards to allow entry into and out of a construction zone, as a non-limiting example.

In some embodiments, the gate assembly 1010 may be configured to receive the ballast 1040, wherein the ballast 1040 may be configured to stabilize the gate adapter system 1000. In some aspects, the ballast 1040 may include a concrete structure or barricade, as non-limiting examples. In some implementations, the gate adapter device 1000 may include electrical components, wherein the gate 1030 may be configured to open and close automatically. In some aspects, the gate adapter device 1000 may include a controller 1050 or one or more sensors configured to send signals to the gate 1030, wherein the horizontal pole may be configured to move upward when an individual, car, or equipment may be detected, as non-limiting examples.

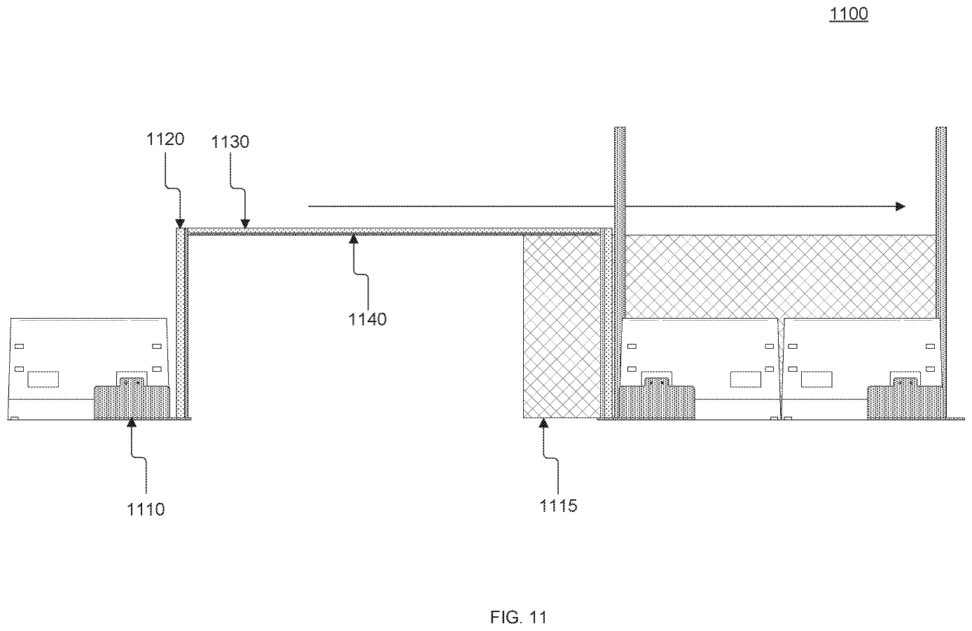

Referring now to FIG. 11, a gate adapter system, according to some embodiments of the present disclosure, is illustrated. In some embodiments, the gate adapter system 1100 may include one or more gate assemblies 1110. In some implementations, the one or more gate assemblies 1110 may include at least one gate mounting post 1120 that may be vertically oriented from the one or more gate assemblies 1110, wherein the at least one gate mounting post 1120 may be configured to receive a gate 1115.

In some embodiments, the gate adapter system 1100 may include at least one horizontal rail 1130, wherein the at least one horizontal rail 1130 may be configured to connect from one at least gate mounting post 1120 to another at least one gate mounting post 1120. In some implementations, the at least one horizontal rail 1130 may be configured to guide the gate 1115 across the gate adapter system 1100, wherein moving along the at least one horizontal rail 1130 may be configured to open and close the gate 1115. In some embodiments, the at least one horizontal pole may include a track mechanism 1140, wherein the gate 1115 may connect to the at least one horizontal rail 1130 at the track mechanism 1140, wherein the gate 1115 may slide open and close on the track mechanism 1140.

In some embodiments, the at least one horizontal rail 1130 may be configured as a structural stabilizer. In such embodiments, the horizontal rail 1130 connects a first gate mounting post 1120 to a second gate mounting post 1120 to maintain a fixed distance between the one or more gate assemblies 1110. This configuration stabilizes the distance between the assemblies, preventing them from splaying or shifting in the event of an impact to the gate 1115 or the ballast. While some embodiments utilize the horizontal rail 1130 as a track mechanism 1140 for sliding the gate, other embodiments utilize the rail 1130 primarily for structural rigidity and alignment of the gate adapter system 1100.

In some embodiments, the horizontal rail 1130 may be a telescoping beam allowed to adjust for varying widths between ballasts before being locked into a rigid position. In some embodiments, the horizontal rail 1130 may include an integrated conduit configured to protect wiring running between the gate assemblies 1110, such as power or data cables for sensors and locks.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

What is claimed is:

1. A gate adapter system with one or more gate assemblies, wherein the one or more gate assemblies include:
at least one gate mounting post that is vertically oriented from the one or more gate assemblies, wherein the at least one gate mounting post is configured to receive a gate;
a post side panel; and
a front side panel parallel to the post side panel, wherein a separation between the front side panel and the post side panel defines a channel configured to receive at least one ballast configured to provide stabilizing weight to the gate adapter system.

2. The gate adapter system of claim 1, further comprising a securing plate attachable to the post side panel and the front side panel, wherein the securing plate is configured to retain the at least one ballast within the channel and prevent displacement during use.

3. The gate adapter system of claim 2, wherein the securing plate is attached to the post side panel and the front side panel by one or more attachment mechanisms selected from the group consisting of bolts, clamps, and welds.

4. The gate adapter system of claim 2, wherein the post side panel, the front side panel, and the securing plate form a rigid structure to maintain the position of the at least one ballast within the channel.

5. The gate adapter system of claim 1, wherein the one or more gate assemblies are configured as a front gate assembly and a back gate assembly, wherein the front gate assembly includes the gate mounting post, and the back gate assembly includes a second gate mounting post.

6. The gate adapter system of claim 5, wherein the one or more gate assemblies are configured to receive a sliding gate, wherein the gate mounting posts of the front gate assembly and the back gate assembly include one or more attachment mechanisms configured to attach to the gate, wherein the front gate assembly is adjacent to an opening with the gate and the back gate assembly defines an end.

7. The gate adapter system of claim 6, wherein the one or more attachment mechanisms include tracks, wherein the tracks include wheels that the gate slides in and out along.

8. The gate adapter system of claim 1, wherein one or more gate assemblies include a patch post receiver configured to connect the gate adapter system to fencing or accessories.

9. The gate adapter system of claim 1, wherein the gate mounting posts include one or more attachment mechanisms, wherein the one or more attachment mechanisms include hinges attachable to the gate, wherein the gate is configured to open along the hinge of the gate mounting posts.

10. The gate adapter system of claim 1, wherein the one or more gate assemblies include one or more stopping mechanisms, wherein the one or more stopping mechanisms are configured to block the gate from opening in a certain direction.

11. The gate adapter system of claim 10, wherein the one or more stopping mechanisms are positioned to prevent the gate from opening outward from a secured area.

12. The gate adapter system of claim 1, wherein the gate is a personnel gate, a vehicle gate, or a barrier arm.

13. The gate adapter system of claim 1, wherein the gate includes a horizontal pole that is connected perpendicularly to the gate mounting post, wherein the horizontal pole is configured to lift upwards.

14. The gate adapter system of claim 1, further including at least one horizontal rail that connects at least one gate mounting post to another at least one gate mounting post to stabilize the distance between the assemblies in case of an impact.

15. An electronic gate adapter system with one or more gate assemblies, wherein the one or more gate assemblies include:
at least one gate mounting post that is vertically oriented from the one or more gate assemblies, wherein the at least one gate mounting post is configured to receive a gate;
a post side panel;
a front side panel parallel to the post side panel, wherein a separation between the front side panel and the post side panel defines a channel configured to receive at least one ballast configured to provide stabilizing weight to the gate adapter system; and
a power supply configured to provide energy to one or more electronic components of the gate adapter system.

16. The electronic gate adapter system of claim 15, further comprising a securing plate attachable to the post side panel and the front side panel, wherein the securing plate is configured to retain the at least one ballast within the channel.

17. The electronic gate adapter system of claim 15, wherein the one or more electronic components include a camera configured to record or photograph the gate and surrounding area.

18. The electronic gate adapter system of claim 15, wherein the one or more electronic components include a light mechanism configured to indicate a status of the gate or provide illumination.

19. The electronic gate adapter system of claim 15, wherein the one or more electronic components include an electronic lock, wherein the electronic lock includes a keypad, a magnetic lock, or a combination thereof configured to secure the gate.

20. The electronic gate adapter system of claim 15, wherein the one or more electronic components include one or more sensors configured to send signals to automatically open and close the gate.
